(19) United States
(12) Patent Application Publication
(10) Pub. No.: US 2015/0095929 A1
(43) Pub. Date: Apr. 2, 2015

(54) METHOD FOR RECOGNIZING CONTENT, DISPLAY APPARATUS AND CONTENT RECOGNITION SYSTEM THEREOF

(71) Applicant: SAMSUNG ELECTRONICS CO., LTD., Suwon-si (KR)

(72) Inventor: Yong-hoon LEE, Seoul (KR)

(73) Assignee: SAMSUNG ELECTRONICS CO., LTD., Suwon-si (KR)

(21) Appl. No.: 14/445,668

(22) Filed: Jul. 29, 2014

(30) Foreign Application Priority Data
Sep. 27, 2013 (KR) 10-2013-0114966

(51) Int. Cl. H04N 21/488; G06K 9/18; H04N 21/25; H04N 21/233; H04N 21/439; H04N 21/81; H04N 7/088; H04N 21/84

(52) U.S. Cl. CPC H04N 21/4884; H04N 7/0882; H04N 7/0884; G06K 9/18; H04N 21/84; H04N 21/233; H04N 21/4394; H04N 21/8106; H04N 21/251
USPC 725/18; 725/19

(57) ABSTRACT

A method for recognizing a content, a display apparatus and a content recognition system thereof are provided. The method for recognizing a content of a display apparatus includes acquiring caption information of an image content which is currently displayed, transmitting the acquired caption information to a content recognition server, when the content recognition server compares the acquired caption information with caption information stored in the content recognition server and recognizes a content corresponding to the acquired caption information, receiving information regarding the recognized content from the content recognition server, and displaying information related to the recognized content.

### CROSS-REFERENCE TO RELATED APPLICATION

This application claims priority from Korean Patent Application No. 10-2013-0114966, filed in the Korean Intellectual Property Office on Sep. 27, 2013, the disclosure of which is incorporated herein by reference in its entirety.

### BACKGROUND

1. Field

Methods, apparatuses, and systems consistent with exemplary embodiments relate to a method for recognizing a content, a display apparatus and a content recognition system thereof, and more particularly, to a method for recognizing an image content which is currently displayed, a display apparatus and a content recognition system thereof.

2. Description of the Related Art

In some cases, a user wishes to know what kind of image content is being displayed in a display apparatus.

Conventionally, image information or audio information has been used to confirm an image content which is currently displayed in a display apparatus. Specifically, a conventional display apparatus analyzes a specific scene using image information, or compares or analyzes image contents using a plurality of image frames (video fingerprinting) to confirm an image content which is currently displayed. In addition, a conventional display apparatus confirms an content which is currently displayed by detecting and comparing specific patterns or sound models of audio using audio information (audio fingerprinting).

However, if image information is used, a large amount of signals should be processed for image analysis, and also high volume of contents need to be transmitted to a server, thereby consuming a log of band widths. Further, using audio information also requires a large amount of signals to process audio, causing problems in confirming a content in real time.

### SUMMARY

An aspect of the exemplary embodiments relates a method for recognizing an image content which is currently displayed by using caption information of the image content, a display apparatus and a content recognition system thereof.

A method for recognizing a content in a display apparatus according to an exemplary embodiment includes acquiring caption information of an image content, transmitting the acquired caption information to a content recognition server, when the content recognition server compares the acquired caption information with caption information stored in the content recognition server and recognizes a content corresponding to the acquired caption information, receiving information regarding the recognized content from the content recognition server, and displaying information related to the recognized content.

The acquiring may include separating caption data included in the image content from the image content and acquiring the caption information.

The acquiring the caption information may comprise performing voice recognition with respect to audio data related to the image content.

The acquiring may include, when caption data of the image content is image data, acquiring caption information through the image data by using optical character recognition (OCR).

When the image content is a broadcast content, the transmitting may include transmitting electronic program guide (EPG) information along with the caption information to the content recognition server.

The content recognition server may recognize the content corresponding to the caption information using the EPG information.

When the caption information is not acquired from caption data included in the image content, the content recognition server may recognize a content corresponding to caption information which has a highest probability of matching with the caption information from among the stored caption information, as the content corresponding to the caption information.

A display apparatus according to an exemplary embodiment includes an image receiver configured to receive an image content, a display configured to display an image, a communicator configured to perform communication with a content recognition server, and a controller configured to control the communicator to acquire caption information of an image content and transmit the acquired caption information to the content recognition server, and when the content recognition server recognizes a content corresponding to the acquired caption information by comparing the acquired caption information with caption information stored in the content recognition server, the controller controls the communicator to receive information related to the recognized content from the content recognition server and controls the display to display information related to the recognized content.

The controller may separate caption data included in the image content from the image content and acquire the caption information.

The display apparatus may further include a voice recognizer configured to perform voice recognition with respect to audio data, and the controller may acquire the caption information by performing voice recognition with respect to audio data related to the image content.

The display apparatus may further include an optical character recognizer (OCR) configured to output text data by analyzing image data, and the controller, when caption data of the image content is image data, may acquire the caption information by outputting the image data as text data by using the OCR.

When the image content is a broadcast content, the controller may control the communicator to transmit electronic program guide (EPG) information along with the caption information, to the content recognition server.

The content recognition server may recognize the content corresponding to the caption information using electronic program guide (EPG) information.

When the caption information is not acquired from caption data included in the image content, the content recognition server may recognize a content corresponding to caption information which has a highest probability of matching with the caption information from among the stored caption information as the content corresponding to the caption information.

A method for recognizing a content in a display apparatus and in a content recognition system including a content recognition server according to an exemplary embodiment includes acquiring caption information of an image content by the display apparatus, transmitting the acquired caption information to the content recognition server by the display apparatus, recognizing a content corresponding to the caption information by comparing the acquired caption information with caption information stored in the content recognition server by the content recognition server, transmitting information related to the recognized content to the display apparatus by the content recognition server, and displaying information related to the recognized content by the display apparatus.

According to an exemplary embodiment, the content recognition server may be external relative to the display apparatus. Also, according to yet another exemplary embodiment, the image content may be currently being displayed on the display apparatus.

A system for recognizing content is provided. The system comprises a display apparatus and a content recognition server, wherein the display apparatus comprises: an image receiver configured to receive an image content; a display configured to display an image; a communicator configured to perform communication with the content recognition server; and a controller configured to control the communicator to acquire caption information of an image content and transmit the acquired caption information to the content recognition server, and when the content recognition server recognizes a content corresponding to the acquired caption information by comparing the acquired caption information with caption information stored in the content recognition server, the controller controls the communicator to receive information related to the recognized content from the content recognition server and controls the display to display information related to the recognized content.

As described above, according to various exemplary embodiments, an image content may be recognized by using caption information. Thus, costs for processing a signal can be reduced in comparison with a conventional method for recognizing an image content, and an image content recognition rate may also be improved.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a view illustrating a content recognition system according to an exemplary embodiment;

FIG. 2 is a block diagram illustrating configuration of a display apparatus briefly according to an exemplary embodiment;

FIG. 3 is a block diagram illustrating configuration of a display information in detail according to an exemplary embodiment;

FIG. 4 is a view illustrating information of a content which is displayed on a display according to an exemplary embodiment;

FIG. 5 is a block diagram illustrating configuration of a server according to an exemplary embodiment;

FIG. 6 is a flowchart provided to explain a method for recognizing a content in a display apparatus according to an exemplary embodiment; and

FIG. 7 is a sequence view provided to explain a method for recognizing a content in a content recognition system according to an exemplary embodiment.

### DETAILED DESCRIPTION

It should be observed that the method steps and system components have been represented by known symbols in the figure, showing only specific details which are relevant for an understanding of the present disclosure. Further, details that may be readily apparent to persons ordinarily skilled in the art may not have been disclosed. In the present disclosure, relational terms such as first and second, and the like, may be used to distinguish one entity from another entity, without necessarily implying any actual relationship or order between such entities.

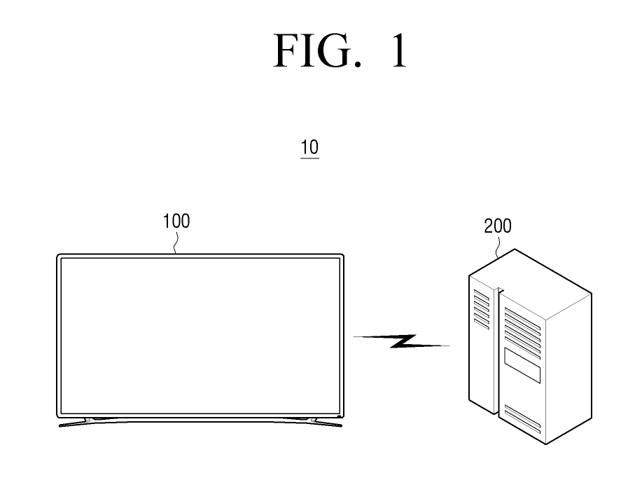

FIG. 1 is a view illustrating a content recognition system 10 according to an exemplary embodiment. The content recognition system 10 includes a display apparatus 100 and a content recognition server 200 as illustrated in FIG. 1. In this case, the display apparatus 100 may be realized as a smart television, but this is only an example. The display apparatus 100 may be realized as a desktop PC, a smart phone, a notebook PC, a tablet PC, a set-top box, etc.

The display apparatus 100 receives an image content from outside and displays the received image content. Specifically, the display apparatus 100 may receive a broadcast content from an external broadcasting station, receive an image content from an external apparatus, or receive video on demand (VOD) image content from an external server.

The display apparatus 100 acquires caption information of an image content which is currently displayed. In particular, if an image content received from outside includes caption data, the display apparatus 100 may separate caption data from the image content and acquire caption information. If the caption data of an image content which is received from outside is in the form of image data, the display apparatus 100 may convert the caption data in the form of image data into text data using optical character recognition (OCR) and acquire caption information. If an image content received from outside does not include caption data, the display apparatus 100 may perform voice recognition with respect to the audio data of the image content and acquire caption information.

Subsequently, the display apparatus 100 transmits the acquired caption information to an external content recognition server 200. In this case, if the image content is a broadcast content, the display apparatus 100 may transmit pre-stored EPG information, etc. along with the caption information as metadata.

When caption information is received, the content recognition server 200 compares the received caption information with caption information stored in a database and recognizes an image content corresponding to the currently-received caption information. Specifically, the content recognition server 200 compares the received caption information with captions of all image contents stored in the database and extracts a content ID which corresponds to the received caption information. In this case, the content recognition server 200 may acquire information regarding a content (for example, title, main actor, genre, play time, etc.) which corresponds to the received caption information using received metadata.

Subsequently, the content recognition server 200 transmits the acquired content information to the display apparatus 100. In this case, the acquired content information may include not only an ID but also addition information such as title, main actor, genre, play time, etc.

The display apparatus 100 displays the acquired content information along with the image content.

Accordingly, the display apparatus may reduce costs for processing a signal in comparison with a conventional method for recognizing an image content, and may improve an image content recognition rate.

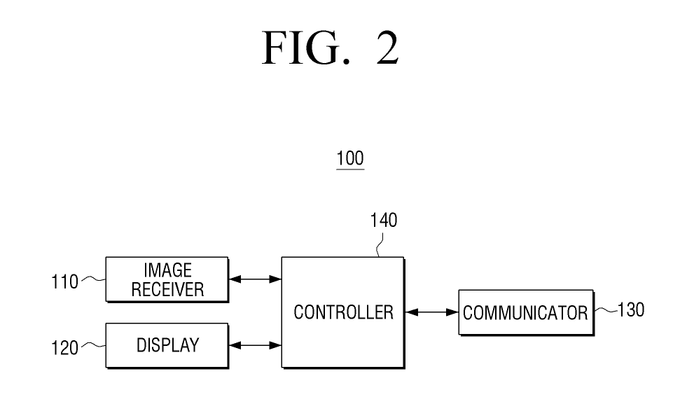

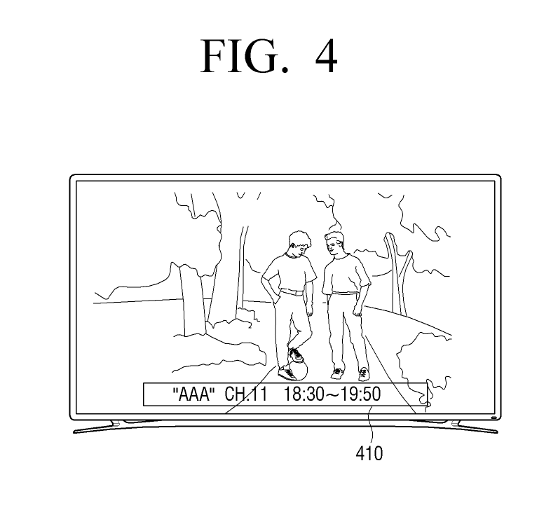

Hereinafter, the display apparatus 100 may be described in greater detail with reference to FIGS. 2 to 4. FIG. 2 is a block diagram illustrating a configuration of the display apparatus 100 briefly according to an exemplary embodiment. As illustrated in FIG. 2, the display apparatus 100 includes an image receiver 110, a display 120, a communicator 130, and a controller 140.

The image receiver 110 receives an image content from outside. Specifically, the image receiver 110 may receive a broadcast content from an external broadcasting station, receive an image content from an external apparatus, receive a VOD image content from an external server in real time, and receive an image content stored in a storage.

The display 120 displays an image content received from the image receiver 110. In this case, when information regarding the image content which is currently displayed is received from the content recognition server 200, the display 120 may also display information regarding the image content.

The communicator 130 performs communication with the external recognition server 200. In particular, the communicator 130 may transmit caption information regarding an image content which is currently displayed to the content recognition server 200. In addition, the communicator 130 may receive information regarding a content corresponding to the caption information from the content recognition server 200.

The controller 140 controls overall operations of the display apparatus 100. In particular, the controller 140 may control the communicator 130 to acquire caption information which is currently displayed on the display 120 and transmit the acquired caption information to the content recognition server 200.

Specifically, if an image content includes caption data and the caption data is in the form of text data, the controller 140 may separate the caption data from the image content and acquire caption information.

Alternatively, if an image content includes caption data and the caption data is in the form of image data, the controller 140 may separate the caption data from the image content and convert the caption data into text data through OCR recognition with respect to the separated caption data in order to acquire caption information in the form of text.

If an image content does not include any caption data, the controller 140 may perform voice recognition with respect to audio data of the image content and acquire caption information of the image content.

In this case, the controller 140 may acquire caption information of all image contents, but this is only an example. The controller 140 may acquire caption information regarding only a predetermined section of the image content.

Subsequently, the controller 140 may control the communicator 130 to transmit the acquired caption information of the image content to the content recognition server 200. In this case, the controller 140 may transmit not only the caption information of the image content but also metadata such as EPG information, etc.

If the content recognition server 200 compares the acquired caption information with caption information pre-stored in database and recognizes a content corresponding to the acquired caption information, the controller 140 may control the communicator 130 to receive information regarding the recognized content from the content recognition server 200. In this case, the controller 140 may receive not only an intrinsic ID of the recognized content but also additional information such as title, genre, main actor, play time, etc. of the image content.

The controller 140 may control the display 120 to display information regarding the received content. That is, the controller 140 may control the display 120 to display an image content which is currently displayed along with information regarding the content. Accordingly, a user may check information regarding the content which is currently displayed more easily and conveniently.

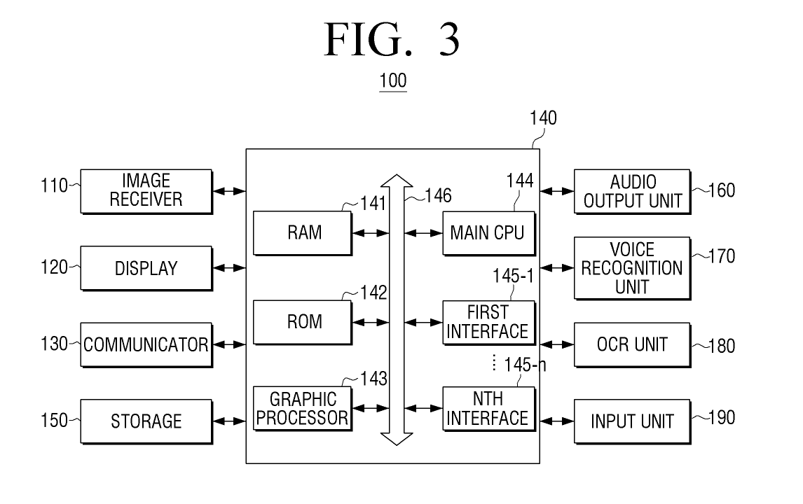

FIG. 3 is a block diagram illustrating a configuration of the display apparatus 100 in detail according to an exemplary embodiment. As illustrated in FIG. 3, the display apparatus 100 includes an image receiver 110, a display 120, a communicator 130, a storage 150, an audio output unit 160, a voice recognition unit 170 (e.g., a voice recognizer), an OCR unit 180, an input unit 190, and a controller 140.

The image receiver 110 receives an image content from outside. In particular, the image receiver 110 may be realized as a tuner to receive a broadcast content from an external broadcasting station, an external input terminal to receive an image content from an external apparatus, a communication module to receive a VOD image content from an external server in real time, an interface module to receive an image content stored in the storage 150, etc.

The display 120 displays various image contents received from the image receiver 110 under the control of the controller 140. In particular, the display 120 may display an image content along with information regarding the image content.

The communicator 130 communicates with various types of external apparatuses or an external server 20 according to various types of communication methods. The communicator 130 may include various communication chips such as a WiFi chip, a Bluetooth chip, a Near Field Communication (NFC) chip, a wireless communication chip, and so on. In this case, the WiFi chip, the Bluetooth chip, and the NFC chip perform communication according to a WiFi method, a Bluetooth method, and an NFC method, respectively. Among the above chips, the NFC chip represents a chip which operates according to an NFC method which uses 13.56 MHz band among various RF-ID frequency bands such as 135 kHz, 13.56 MHz, 433 MHz, 860-960 MHz, 2.45 GHz, and so on. In the case of the WiFi chip or the Bluetooth chip, various connection information such as SSID and a session key may be transmitted/received first for communication connection and then, various information may be transmitted/received. The wireless communication chip represents a chip which performs communication according to various communication standards such as IEEE, Zigbee, 3^{rd} Generation (3G), 3^{rd} Generation Partnership Project (3GPP), Long Term Evolution (LTE) and so on.

In particular, the communicator 130 performs communication with the external content recognition server 200. Specifically, the communicator may transmit caption information regarding an image content which is currently displayed to the content recognition server 200, and may receive information regarding an image content which is currently displayed from the content recognition server 200.

In addition, the communicator 130 may acquire additional information such as EPG data from an external broadcasting station or an external server.

The storage 150 stores various modules to drive the display apparatus 100. For example, the storage 150 may store software including a base module, a sensing module, a communication module, a presentation module, a web browser module, and a service module. In this case, the base module is a basic module which processes a signal transmitted from each hardware included in the display apparatus 200 and transmits the processed signal to an upper layer module. The sensing module collects information from various sensors, and analyzes and manages the collected information, and may include a face recognition module, a voice recognition module, a motion recognition module, an NFC recognition module, and so on. The presentation module is a module to compose a display screen, and may include a multimedia module to reproduce and output multimedia contents and a UI rendering module to perform UI and graphic processing. The communication module is a module to perform communication with external devices. The web browser module is a module to access a web server by performing web browsing. The service module is a module including various applications to provide various services.

As described above, the storage 150 may include various program modules, but some of the various program modules may be omitted, changed, or added according to the type and characteristics of the display apparatus 100. For example, if the display apparatus 100 is realized as a tablet PC, the base module may further include a location determination module to determine a GPS-based location, and the sensing module may further include a sensing module to sense the motion of a user.

In addition, the storage 150 may store information regarding an image content such as EPG data, etc.

The audio output unit 160 is an element to output not only various audio data which is processed by the audio processing module but also various alarms and voice messages.

The voice recognition unit 170 is an element to perform voice recognition with respect to a user voice or audio data. Specifically, the voice recognition unit 170 may perform voice recognition with respect to audio data using a sound model, a language model, a grammar dictionary, etc. Meanwhile, in the exemplary embodiment, the voice recognition unit 170 includes all of the sound model, language model, grammar dictionary, etc. but this is only an example. The voice recognition unit 170 may include at least one of the sound model, language model and grammar dictionary. In this case, the elements which are not included in the voice recognition unit 170 may be included in an external voice recognition server.

In particular, the voice recognition unit 170 may generate caption data of an image content by performing voice recognition with respect to audio data of an image content.

The OCR unit 180 (e.g., optical character recognizer) is an element which recognizes a text included in image data by using a light. In particular, when caption data is realized as image data, the OCR unit 180 may output the caption data in the form of text by recognizing the caption data in the form of an image.

The input unit 190 receives a user command to control the display apparatus 100. In particular, the input unit 190 may be realized as a remote controller, but this is only an example. The input unit 190 may be realized as various input apparatuses such as a motion input apparatus, a pointing device, a mouse, etc.

The controller 140 controls overall operations of the display apparatus 100 using various programs stored in the storage 150.

The controller 140, as illustrated in FIG. 3, comprises a random access memory (RAM) 141, a read-only memory (ROM) 142, a graphic processor 143, a main central processing unit (CPU) 144, a first to a nth interface 145-1˜145-n, and a bus 146. In this case, the RAM 141, the ROM 142, the graphic processor 143, the main CPU 144, and the first to the nth interface 145-1˜145-n may be interconnected through the bus 146.

The ROM 142 stores a set of commands for system booting. If a turn-on command is input and thus, power is supplied, the main CPU 144 copies the O/S stored in the storage 150 in the RAM 141 according to a command stored in the ROM 142, and boots a system by executing the O/S. Once the booting is completed, the main CPU 144 copies various application programs stored in the storage 150 in the RAM 141, and performs various operations by executing the application programs copied in the RAM 141.

The graphic processor 143 generates a screen including various objects such as an icon, an image, a text, etc. using an operation unit (not shown) and a rendering unit (not shown). The operation unit computes property values such as a coordinates, a shape, a size, and a color of each object to be displayed according to the layout of a screen using a control command received from the input unit 190. The rendering unit generates screens of various layouts including objects based on the property values computed by the operation unit. The screens generated by the rendering unit are displayed in a display area of the display 120.

The main CPU 144 accesses the storage 150 and performs booting using the O/S stored in the storage 150. In addition, the main CPU 144 performs various operations using various programs, contents, data, etc. stored in the storage 150.

The first to the nth interface 145-1 to 145-n are connected to the above-described various components. One of the interfaces may be a network interface which is connected to an external apparatus via network.

In particular, the controller 140 may control the communicator 130 to acquire caption information of an image content which is currently displayed on the display 120 and transmit the acquired caption information to the content recognition server 200.

Specifically, if “AAA” image content is currently displayed in the display 120, the controller 140 may acquire caption information regarding the “AAA” image content.

In particular, if the “AAA” image content includes caption data in the form of text data, the controller 140 may acquire caption information by separating the caption data in the form of text data from the “AAA” image content.

If the “AAA” image content includes caption data in the form of image data, the controller 140 may acquire caption information by separating the caption data in the form of image data from the “AAA” image content and recognizing the text included in the image data using the OCR unit 180.

Alternatively, if the “AAA” image content does not include caption data, the controller 140 may control the voice recognition unit 170 to perform voice recognition with respect to audio data of the “AAA” image content. When voice recognition with respect to audio data of the “AAA” image content is performed, the controller 140 may acquire caption information which is converted to be in the form of text. Meanwhile, in the above exemplary embodiment, caption information is acquired through the voice recognition unit 170 inside the display apparatus, but this is only an example. The caption information may be acquired through voice recognition using an external voice recognition server.

Subsequently, the controller 140 may control the communicator 130 to transmit the caption information of the “AAA” image content to the content recognition server 200. In this case, if the “AAA” image content is a broadcast content, the controller 140 may transmit not only the caption information of the “AAA” image content but also EPG information as metadata.

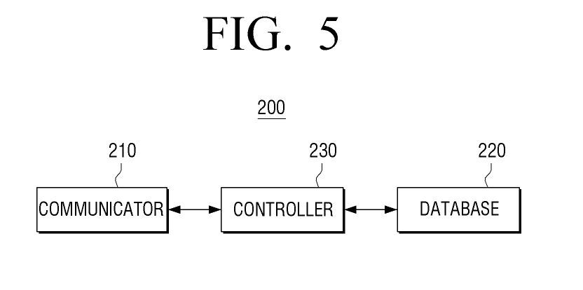

The content recognition server 200 compares the caption information received from the display apparatus 100 with caption information stored in the database and recognizes a content corresponding to the caption information received from the display apparatus 100. The method of recognizing a content corresponding to caption information by the content recognition server 200 will be described in detail with reference to FIG. 5.

If information regarding a content corresponding to caption information is received from the content recognition server 200, the controller 140 may control the display 120 to display information regarding the received content. Specifically, if information regarding the “AAA” image content (for example, title, channel information, play time information, etc.) is received, the controller 140 may control the display 120 to display information 410 regarding the “AAA” image content at the lower area of the display screen along with the “AAA” image content which is currently displayed.

Meanwhile, in the above exemplary embodiment, information regarding an image content corresponding to caption information is displayed, but this is only an example. The information regarding an image content may be output in the form of audio. In addition, if the display apparatus 100 is realized as a set-top box, the information regarding an image content may be transmitted to an external display.

As described above, by recognizing an image which is currently displayed using caption information, the display apparatus 100 may recognize the content more rapidly and accurately while processing less signals in comparison with the conventional method of recognizing an image content.

Hereinafter, the content recognition server 200 will be described in greater detail with reference to FIG. 5. As illustrated in FIG. 5, the content recognition server 200 includes a communicator 210, database 220 and a controller 230.

The communicator 210 performs communication with the external display apparatus 100. In particular, the communicator 210 may receive caption information and metadata from the external display apparatus 100, and may transmit information regarding an image content corresponding to the caption information to the external display apparatus 100.

The database 220 stores caption information of an image content. In particular, the database 220 may store caption information regarding an image content which is previously released, and in the case of a broadcast content, the database 220 may receive and store caption information from outside in real time. In this case, the database 220 may match and store an intrinsic ID and metadata (for example, store additional information such as title, main actor, genre, play time. etc.) along with a caption of the image content. In this case, the metadata may be received from the external display apparatus 100, but this is only an example. The metadata may be received from an external broadcasting station or another server.

The controller 230 controls overall operations of the content recognition server 200. In particular, the controller 230 may compare caption information received from the external display apparatus 100 with caption information stored in the database 220, and acquire information regarding an image content corresponding to the caption information received from the display apparatus 100.

Specifically, the controller 230 compares caption information received from the external display apparatus 100 with caption information stored in the database 220, and extracts an intrinsic ID of a content corresponding to the caption information received from the display apparatus 100. The controller 230 may check information regarding an image content corresponding to the intrinsic ID using metadata.

If metadata is not stored in the database, the controller 230 may generate new ID information and check information regarding an image content through various external sources (for example, web-based data).

If caption information is acquired through OCR or voice recognition, there may be some disparities between the caption information and a real caption. Therefore, if caption information which is acquired through OCR or voice recognition is received, the controller 230 may perform content recognition through partial string matching instead of absolute string matching. For example, the controller 230 may perform content recognition using a Levenshtein distance method or a n-gram analysis method.

In particular, the above-described partial string matching may be based on a statistical method and thus, the controller 230 may extract caption information which has the highest probability of matching with the caption information received from the display apparatus 100, but this is only an example. A plurality of candidate caption information of which probability of matching with the caption information received from the display apparatus 100 is higher than a predetermined value may also be extracted.

If a content corresponding to the caption information received from the display apparatus 100 is recognized, the controller 230 may acquire information regarding an image content corresponding to the caption information received from the display apparatus 100 using metadata. For example, the controller 230 may acquire information regarding contents such as title, main actor, genre, play time, etc. of the image content using metadata.

When information regarding the image content is acquired, the controller 230 may control the communicator 210 to transmit information regarding the image content to the external display apparatus 100.

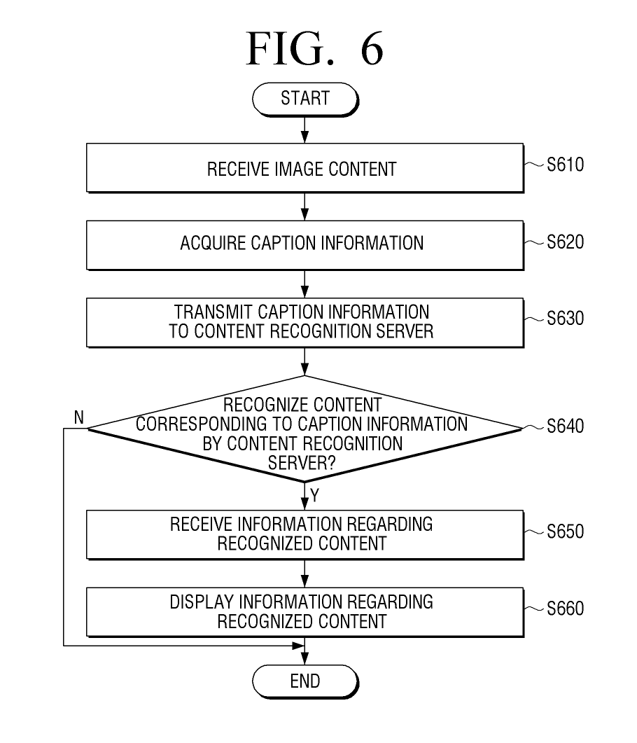

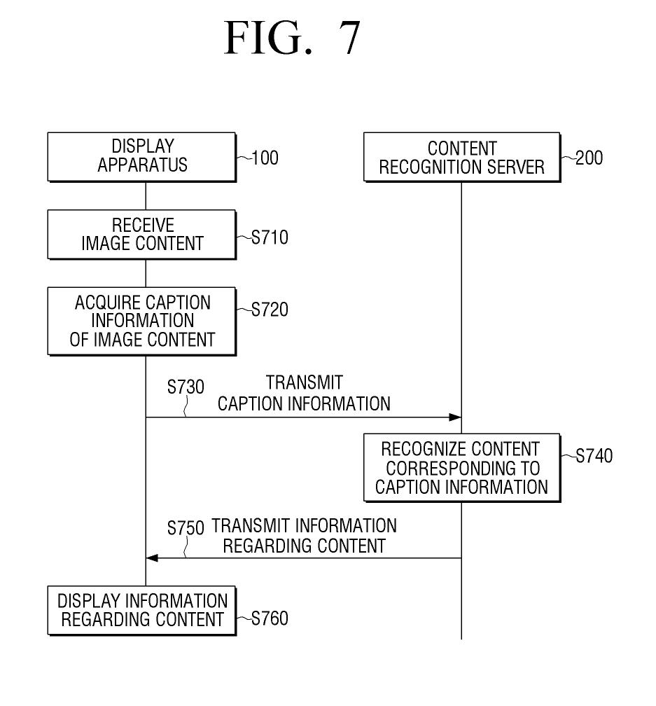

Hereinafter, a method of recognizing a content will be described with reference to FIGS. 6 and 7. FIG. 6 is a method for recognizing a content in the display apparatus 100 according to an exemplary embodiment.

First of all, the display apparatus 100 receives an image content from outside (S610). The display apparatus 100 may display the received image content.

The display apparatus 100 acquires caption information regarding an image content which is currently displayed (S620). Specifically, the display apparatus 100 may acquire caption information by separating caption data from the image content, but this is only an example. The display apparatus 100 may acquire caption information using OCR recognition, voice recognition, etc.

The display apparatus 100 transmits the caption information to the content recognition server 200 (S630). In this case, the display apparatus 100 may transmit metadata such as EPG information along with the caption information.

It is determined whether the content recognition server 200 recognizes a content corresponding to the caption information (S640).

If the content recognition server 200 recognizes a content corresponding to the caption information (S640-Y), the display apparatus 100 receives information regarding the recognized content (S650). In this case, the information regarding the recognized content may include various additional information such as title, genre, main actor, play time, summary information, shopping information, etc. of the image content.

The display apparatus 100 displays information regarding the recognized content (S660).

FIG. 7 is a sequence view provided to explain a method for recognizing a content in a content recognition system 10 according to an exemplary embodiment.

First of all, the display apparatus 100 receives an image content from outside (S710). In this case, the received image content may be a broadcast content, a movie content, a VOD image content, etc.

Subsequently, the display apparatus 100 acquires caption information of the image content (S720). Specifically, if caption data in the form of text is stored in the image content, the display apparatus 100 may separate the caption data from the image content data and acquire caption information. If caption data in the form of an image is stored in the image content data, the display apparatus 100 may convert the caption data in the form of image into data in the form of text using OCR recognition and acquire caption information. If there is no caption data in the image content data, the display apparatus 100 may acquire caption information by performing voice recognition with respect to audio data of the image content.

The display apparatus 100 transmits the acquired caption information to the content recognition server 200 (S730).

The content recognition server 200 recognizes a content corresponding to the received caption information (S740). Specifically, the content recognition server 200 may compare the received caption information with caption information stored in the database 220 and recognize a content corresponding to the received caption information. The method of recognizing a content by the content recognition server 200 has already been described above with reference to FIG. 5, so further description will not be provided.

Subsequently, the content recognition server 200 transmits information regarding the content to the display apparatus 100 (S750).

The display apparatus 100 displays information related to the content received from the content recognition server 200 (S760).

As described above, the content recognition system 10 recognizes an image content which is currently displayed using caption information and thus, the costs for processing signals may be reduced in comparison with the conventional method of recognizing an image content, and an image content recognition rate may be improved.

Meanwhile, the method for recognizing a content in a display apparatus according to the above-described various exemplary embodiments may be realized as a program and provided in the display apparatus. In this case, a program including the method of recognizing a content in a display apparatus may be provided through a non-transitory computer readable medium.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM and provided therein.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

[Description of Reference Numerals]

| | |
|---|---|
| 110: image receiver | 120: display |
| 130: communicator | 140: controller |
| 150: storage | 160: audio output unit |
| 170: voice recognition unit | 180: OCR unit |
| 190: input unit | |

What is claimed is:

1. A method for recognizing a content in a display apparatus, the method comprising:
acquiring caption information of an image content;
transmitting the acquired caption information to a content recognition server;
when the content recognition server compares the acquired caption information with caption information stored in the content recognition server and recognizes a content corresponding to the acquired caption information, receiving information regarding the recognized content from the content recognition server; and
displaying information related to the recognized content.

2. The method as claimed in claim 1, wherein the acquiring comprises separating caption data included in the image content from the image content and acquiring the caption information.

3. The method as claimed in claim 1, wherein the acquiring the caption information comprises performing voice recognition with respect to audio data related to the image content.

4. The method as claimed in claim 1, wherein the acquiring comprises, when caption data of the image content is image data, acquiring the caption information through the image data by using optical character recognition (OCR).

5. The method as claimed in claim 1, wherein when the image content is a broadcast content, the transmitting comprises transmitting electronic program guide (EPG) information along with the caption information to the content recognition server.

6. The method as claimed in claim 5, wherein the content recognition server recognizes the content corresponding to the caption information using the EPG information.

7. The method as claimed in claim 1, wherein when the caption information is not acquired from caption data included in the image content, the content recognition server recognizes a content corresponding to caption information which has a highest probability of matching with the caption information from among the stored caption information, as the content corresponding to the caption information.

8. A display apparatus, comprising:
an image receiver configured to receive an image content;
a display configured to display an image;
a communicator configured to perform communication with a content recognition server; and
a controller configured to control the communicator to acquire caption information of an image content and transmit the acquired caption information to the content recognition server, and when the content recognition server recognizes a content corresponding to the acquired caption information by comparing the acquired caption information with caption information stored in the content recognition server, the controller controls the communicator to receive information related to the recognized content from the content recognition server and controls the display to display information related to the recognized content.

9. The display apparatus as claimed in claim 8, wherein the controller separates caption data included in the image content from the image content and acquires the caption information.

10. The display apparatus as claimed in claim 8, further comprising:
a voice recognizer configured to perform voice recognition with respect to audio data,
wherein the controller acquires the caption information by performing voice recognition with respect to audio data related to the image content.

11. The display apparatus as claimed in claim 8, further comprising:
an optical character recognizer (OCR) configured to output text data by analyzing image data,
wherein the controller, when caption data of the image content is image data, acquires the caption information by outputting the image data as text data by using the OCR.

12. The display apparatus as claimed in claim 8, wherein when the image content is a broadcast content, the controller controls the communicator to transmit electronic program guide (EPG) information along with the caption information, to the content recognition server.

13. The display apparatus as claimed in claim 8, wherein the content recognition server recognizes the content corresponding to the caption information using electronic program guide (EPG) information.

14. The display apparatus as claimed in claim 8, wherein when the caption information is not acquired from caption data included in the image content, the content recognition server recognizes a content corresponding to caption information which has a highest probability of matching with the caption information from among the stored caption information, as the content corresponding to the caption information.

15. A method for recognizing a content in a display apparatus and in a content recognition system including a content recognition server, the method comprising:
acquiring caption information of an image content by the display apparatus;
transmitting the acquired caption information to the content recognition server by the display apparatus;
recognizing a content corresponding to the caption information by comparing the acquired caption information with caption information stored in the content recognition server by the content recognition server;
transmitting information related to the recognized content to the display apparatus by the content recognition server; and
displaying information related to the recognized content by the display apparatus.

16. A system for recognizing content, said system comprising a display apparatus and a content recognition server,
wherein the display apparatus comprises:
an image receiver configured to receive an image content;
a display configured to display an image;
a communicator configured to perform communication with the content recognition server; and
a controller configured to control the communicator to acquire caption information of an image content and transmit the acquired caption information to the content recognition server, and when the content recognition server recognizes a content corresponding to the acquired caption information by comparing the acquired caption information with caption information stored in the content recognition server, the controller controls the communicator to receive information related to the recognized content from the content recognition server and controls the display to display information related to the recognized content.
